(19) United States
(12) Patent Application Publication
(10) Pub. No.: US 2024/0019694 A1
(43) Pub. Date: Jan. 18, 2024

(54) APPARATUS FOR GENERATING A VIRTUAL IMAGE, COMPRISING AN ADJUSTMENT MECHANISM FOR ANTIREFLECTIVE LAMELLAE

(71) Applicant: Continental Automotive Technologies GmbH, Hannover (DE)

(72) Inventors: Michael Döbler, Seligenstadt (DE); Klaus Seifert, Darmstadt (DE); Felicitas Wille, Darmstadt (DE)

(73) Assignee: Continental Automotive Technologies GmbH, Hannover (DE)

(21) Appl. No.: 18/037,197

(22) PCT Filed: Nov. 2, 2021
(86) PCT No.: PCT/DE2021/200171

§ 371 Date: May 16, 2023

(30) Foreign Application Priority Data
Nov. 17, 2020 (DE) 10 2020 214 457.5

(51) Int. Cl. G02B 27/01

(52) U.S. Cl. CPC G02B 27/0101; G02B 2027/0118

(57) ABSTRACT

An apparatus for generating a virtual image having a display element for generating an image, an optical waveguide for expanding an exit pupil, and an anti-glare element arranged downstream of the optical waveguide in the beam path, wherein the anti-glare element is a shutter that has a plurality of slats which, in their end regions, have flat reinforcing elements which protrude beyond the slats is disclosed.

### CROSS REFERENCE TO RELATED APPLICATIONS

This U.S. patent application claims the benefit of PCT patent application No. PCT/DE2021/200171, filed Nov. 2, 2021, which claims the benefit of German patent application No. 10 2020 214 457.5, filed Nov. 17, 2020, both of which are hereby incorporated by reference

### TECHNICAL FIELD

The present disclosure relates to an adjustment mechanism for antireflection slats of a display device having a picture generating unit with a display element for displaying an image and an optical unit for projecting the image onto a projection surface.

### BACKGROUND

Such display devices may, for example, be used for a head-up display for transportation. A head-up display, also referred to as a HUD, is intended to mean a display system in which the viewer can maintain their viewing direction since the contents to be represented are superimposed on their visual field. While such systems were originally used primarily in the aeronautical sector due to their complexity and costs, they are now also being used in large-scale production in the automotive sector.

Head-up displays generally consist of an image generator, an optical unit, and a mirror unit. The image generator generates the image. The optical unit directs the image onto the mirror unit. The image generator is often also referred to as a picture generating unit or PGU. The mirror unit is a partially reflecting, light-transmissive pane. The viewer thus sees the contents represented by the image generator as a virtual image and at the same time sees the real world behind the pane. In the automotive sector, the windshield is often used as mirror unit, and its curved shape must be taken into account in the representation. Due to the interaction of the optical unit and the mirror unit, the virtual image is an enlarged representation of the image generated by the image generator.

The viewer can see the virtual image only from the position of the so-called eyebox. The eyebox refers to a region, the height and width of which correspond to a theoretical viewing window. As long as one of the viewer's eyes is within the eyebox, all elements of the virtual image are visible to that eye. If, on the other hand, the eye is outside the eyebox, the virtual image is visible only partially or not at all to the viewer. The larger the eyebox is, the less restricted the viewer is in choosing their seating position.

The size of the eyebox of conventional head-up displays is limited by the size of the optical unit. One approach for enlarging the eyebox is to couple the light coming from the picture generating unit into an optical waveguide. The light that is coupled into the optical waveguide undergoes total internal reflection at the interfaces of the latter and is thus guided within the optical waveguide. In addition, a portion of the light is coupled out at a multiplicity of positions along the propagation direction. Owing to the optical waveguide, expansion of the exit pupil is achieved in this way. The effective exit pupil is composed here of images of the aperture of the image generation system.

Against this background, US 2016/0124223 A1 describes a display device for virtual images. The display device comprises an optical waveguide, which causes light that emanates from a picture generating unit and is incident through a first light incidence surface to repeatedly undergo total internal reflection in order to travel in a first direction away from the first light incidence surface. The optical waveguide also has the effect that a portion of the light guided in the optical waveguide emerges outward through regions of a first light exit surface, which extends in the first direction. The display device further comprises a first diffraction grating on the light-incidence side, which diffracts incident light so as to make the diffracted light enter the optical waveguide, and a first light-emergence diffraction grating, which diffracts the light that is incident from the optical waveguide. US 2012/0224062 A1 also relates to a display device for virtual images, having an optical waveguide.

In the currently known design of such an apparatus, in which the optical waveguide consists of glass plates within which diffraction gratings or holograms are arranged, a problem arises if light is incident from outside. Stray light may enter the user's eye due to reflections of the light that is incident from outside. The contrast of the virtual image perceived by the user is furthermore reduced.

In conventional apparatuses, reflective components may therefore be tilted and combined with glare traps so that reflections do not reach the region in which the driver's eye is expected to be. Alternatively, antireflection coatings are employed and structural roughness is used in order to reduce the reflection intensity.

Tilting the components takes up significant installation space, which is limited in automobiles. Furthermore, the performance of the components is generally reduced with tilted installation. Layers and structures lessen the achievable intensity, but the reflections generally remain clearly visible and significantly reduce the contrast.

It is an object of the present disclosure to propose an improved apparatus for generating a virtual image, with which the influence of stray light is reduced.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

An apparatus according to the disclosure for generating a virtual image has a display element for generating an image, an optical waveguide for expanding an exit pupil, and an anti-glare element, which is arranged downstream of the optical waveguide in the beam path and is a shutter that has a plurality of slats which, in their end regions have flat reinforcing elements which protrude beyond the slats. Projecting parts of the reinforcing elements are used to fasten the slats. Undefined force action, such as for example takes place on the reinforcing elements when they are clamped, is removed by the slats. Negative influences on their shape, and therefore on their shading effect, are therefore reduced or entirely avoided.

According to the disclosure, the reinforcing elements are resiliently configured, for example as springs. This allows suspension similar to a leaf spring. Impacts from outside are not transmitted directly onto the delicate slats, which increases their lifetime.

According to the disclosure, slats are arranged between the reinforcing elements of neighboring spacer platelets. The spacing of the slats may be set by the thickness of the spacer platelets. If the spacer platelets are configured relatively thinly, the spacing is set by the number of spacer platelets arranged stacked between two slats.

The spacer platelets have a different material thickness at different locations of the shutter. An angle gradient of the slats may therefore be set in a straightforward way.

According to the disclosure, the reinforcing elements protrude upward and downward beyond the slats, and the upwardly protruding regions of the reinforcing elements are arranged displaceably in relation to the downwardly protruding regions of the reinforcing elements. Adjustment of the setting angle of the slats is therefore made possible by displacing said regions relative to one another.

Spacer platelets arranged between the upwardly protruding regions are fixed by fixing elements to an upper or lower row. The relative position of the slats with respect to one another is defined.

According to the disclosure, the spacer platelets have a slant which corresponds to a preferred direction of the slats. The reinforcing elements, in the preferred direction, have no prestress, or only a minor prestress. Since the preferred direction is occupied over prolonged periods of time, less material fatigue therefore takes place.

Further features of the present disclosure will be evident from the following description and the appended claims in conjunction with the figures.

### BRIEF DESCRIPTION OF THE DRAWINGS

FIG. 1 schematically shows a head-up display according to the prior art for a motor vehicle;

FIG. 2 shows an optical waveguide with two-dimensional enlargement;

FIG. 3 schematically shows a head-up display with an optical waveguide;

FIG. 4 schematically shows a head-up display with an optical waveguide in a motor vehicle;

FIG. 5 schematically shows a head-up display with an optical waveguide and antireflection as an anti-glare element;

FIG. 6 shows an alternative optical waveguide with two-dimensional enlargement;

FIG. 7 schematically shows an apparatus according to the disclosure for generating a virtual image;

FIG. 8 shows a shutter and a detail enlargement thereof;

FIG. 9 shows slats with flat reinforcing elements;

FIG. 10 shows an arrangement of spacer platelets;

FIG. 11 shows an embodiment of the disclosure with an angle gradient;

FIG. 12 shows the principle of the adjustment of the setting angle;

FIG. 13 shows the fixing of spacer platelets; and

FIG. 14 shows spacer platelets with a slant.

### DETAILED DESCRIPTION

For a better understanding of the principles of the present disclosure, embodiments of the disclosure will be explained in more detail below with the aid of the figures. The same references are used in the figures for identical or functionally identical elements and are not necessarily described again for each figure. It is to be understood that the invention is not limited to the illustrated embodiments and that the features described may also be combined or modified without departing from the scope of protection of the invention as it is defined in the appended claims.

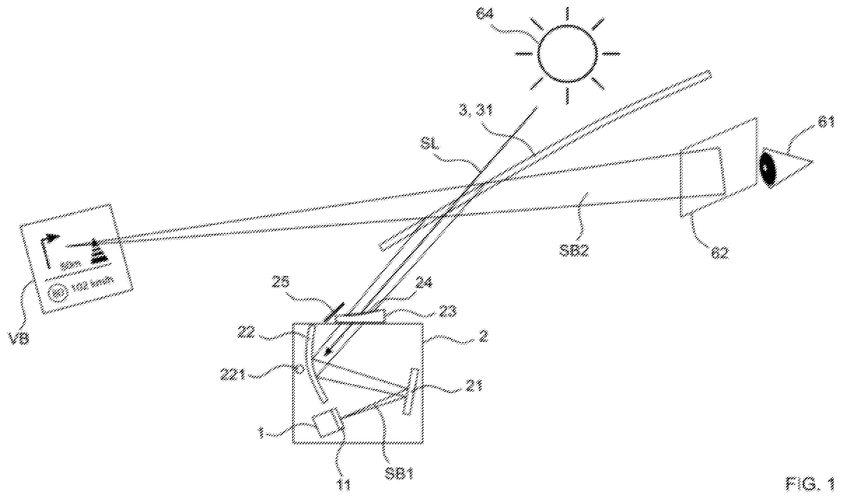

First, the basic concept of a head-up display with an optical waveguide will be explained with the aid of FIGS. 1 to 4.

FIG. 1 shows a schematic diagram of a head-up display according to the prior art for a motor vehicle. The head-up display has an image generator 1, an optical unit 2 and a mirror unit 3. A beam of rays SB1 emanates from a display element 11 and is reflected by a folding mirror 21 onto a curved mirror 22, which reflects it in the direction of the mirror unit 3. The mirror unit 3 is represented here as a windshield 31 of a motor vehicle. From there, the beam of rays SB2 travels in the direction of an eye 61 of a viewer.

The viewer sees a virtual image VB that is located outside the motor vehicle, above the engine hood or even in front of the motor vehicle. Due to the interaction between the optical unit 2 and the mirror unit 3, the virtual image VB is an enlarged representation of the image displayed by the display element 11. A speed limit, the current vehicle speed and navigation instructions are symbolically represented here. As long as the eye 61 is within the eyebox 62, which is indicated by a rectangle, all elements of the virtual image are visible to the eye 61. If the eye 61 is outside the eyebox 62, the virtual image VB is visible only partially or not at all to the viewer. The larger the eyebox 62 is, the less restricted the viewer is when choosing their seating position.

The curvature of the curved mirror 22 serves to condition the beam path and thus to ensure a larger image and a larger eyebox 62. In addition, the curvature compensates for a curvature of the windshield 31, with the result that the virtual image VB corresponds to an enlarged reproduction of the image represented by the display element 11. The curved mirror 22 is rotatably mounted by a bearing 221. The rotation of the curved mirror 22 that this allows thereby makes it possible to displace the eyebox 62 and thus to adapt the position of the eyebox 62 to the position of the eye 61. The folding mirror 21 serves to ensure that the path traveled by the beam of rays SB1 between the display element 11 and the curved mirror 22 is long but, at the same time, that the optical unit 2 is nevertheless compact. The optical unit 2 is delimited from the environment by a transparent cover 23. The optical elements of the optical unit 2 are thus protected, for example against dust inside the vehicle. Furthermore, there is an optical film 24 or a coating, which is intended to prevent incoming sunlight SL from reaching the display element 11 via the mirrors 21, 22, on the cover 23. Said display element 11 could otherwise be temporarily or permanently damaged by the resulting development of heat. In order to prevent this, for example, an infrared component of the sunlight SL is filtered out or at least partially reflected by the optical film 24. Glare protection 25 serves to shade light incident from the front so that it is not reflected by the cover 23 in the direction of the windshield 31, which could cause the viewer to be dazzled. In addition to sunlight SL, the light from another stray light source 64 may also reach the display element 11.

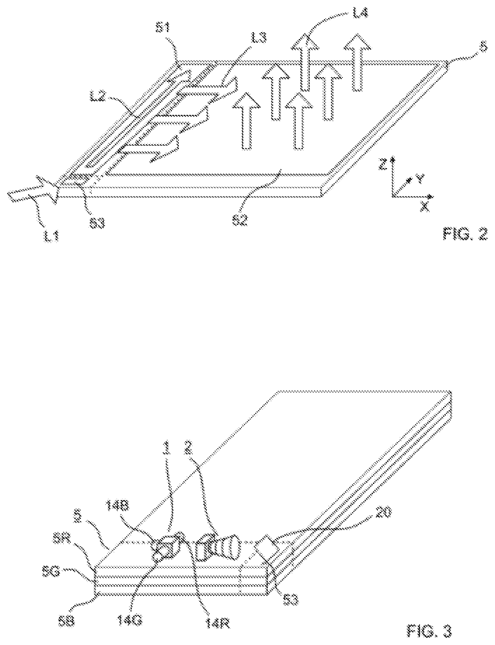

FIG. 2 shows a schematic spatial illustration of an optical waveguide with two-dimensional enlargement. The lower left region shows an input coupling hologram 53, by which light L1 coming from a picture generating unit (not shown) is coupled into the optical waveguide 5. It propagates therein upward to the right in the drawing, according to the arrow L2. In this region of the optical waveguide 5, there is a folding hologram 51 that acts similarly to many partially transmissive mirrors arranged one behind the other and generates a light beam that is broadened in the Y-direction and propagates in the X-direction. This is indicated by three arrows L3. In the part of the optical waveguide 5 that extends to the right in the figure, there is an output coupling hologram 52 that likewise acts similarly to many partially transmissive mirrors arranged one behind the other and couples out light, indicated by arrows L4, upward in the Z-direction from the optical waveguide 5. In this case, broadening takes place in the X-direction, so that the original incident light beam L1 leaves the optical waveguide 5 as a light beam L4 that is enlarged in two dimensions.

FIG. 6 shows a schematic illustration of an optical waveguide with two-dimensional enlargement, which is an alternative to FIG. 2. Here, the output coupling hologram 52 is configured in such a way that it couples light out not perpendicularly to the surface of the optical waveguide 5 but at an angle with respect to the Z-direction, as illustrated by the arrows L4. In this way, the optical waveguide may be arranged according to the available installation space, without having to allow for perpendicular emergence of the light beam enlarged in two dimensions.

FIG. 3 shows a spatial illustration of a head-up display with three optical waveguides 5R, 5G, 5B, which are arranged one above the other and each stand for an elementary color red, green, and blue. Together they form the optical waveguide 5. The holograms 51, 52, 53 present in the optical waveguide 5 are wavelength-dependent, so that one optical waveguide 5R, 5G, 5B is respectively used for one of the elementary colors. An image generator 1 and an optical unit 2 are illustrated above the optical waveguide 5. The optical unit 2 has a mirror 20, by which the light generated by the image generator 1 and shaped by the optical unit 2 is deflected in the direction of the respective input coupling hologram 53. The image generator 1 has three light sources 14R, 14G, 14B for the three elementary colors. It can be seen that the entire unit shown has a small overall height compared with its light-emitting surface.

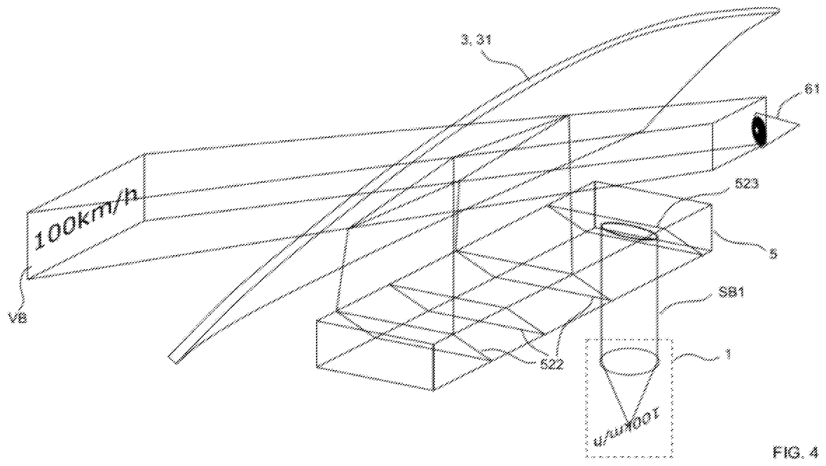

FIG. 4 shows a head-up display in a motor vehicle similar to FIG. 1, but here in a spatial illustration and with an optical waveguide 5. It shows the schematically indicated image generator 1, which produces a parallel beam of rays SB1 that is coupled into the optical waveguide 5 by means of the mirror plane 523. The optical unit is not illustrated for the sake of simplicity. A plurality of mirror planes 522 each reflect some of the light incident thereon into the direction of the windshield 31, i.e. the mirror unit 3. From here, the light is reflected in the direction of the eye 61. The viewer sees a virtual image VB above the engine hood or at an even farther distance in front of the motor vehicle.

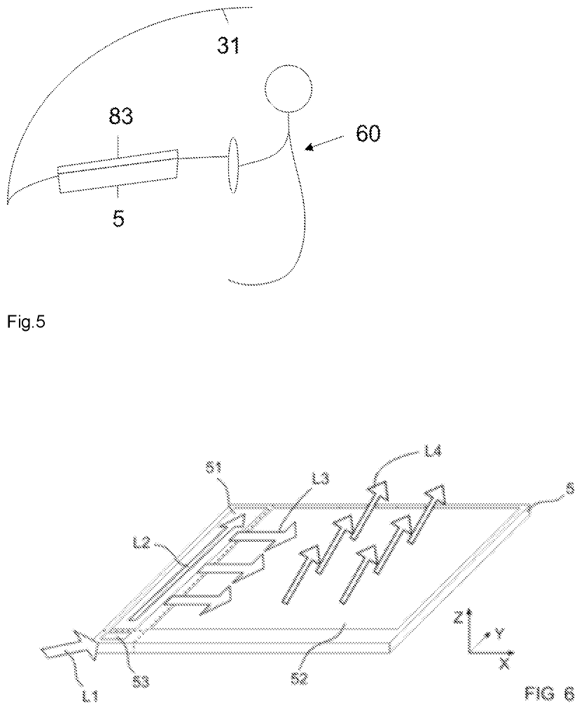

FIG. 5 schematically shows a head-up display with an optical waveguide 5 and a shutter 83 for antireflection as an anti-glare element. Light incident through the windshield 31 is blocked by the slats (not shown here) of the shutter 83 and does not reach the eye of the observer 60. Light emitted by the waveguide 5 in the direction of the eye of the observer 60 travels parallel to the slats of the shutter 31, and therefore passes through the latter and enters the eye of the observer 60.

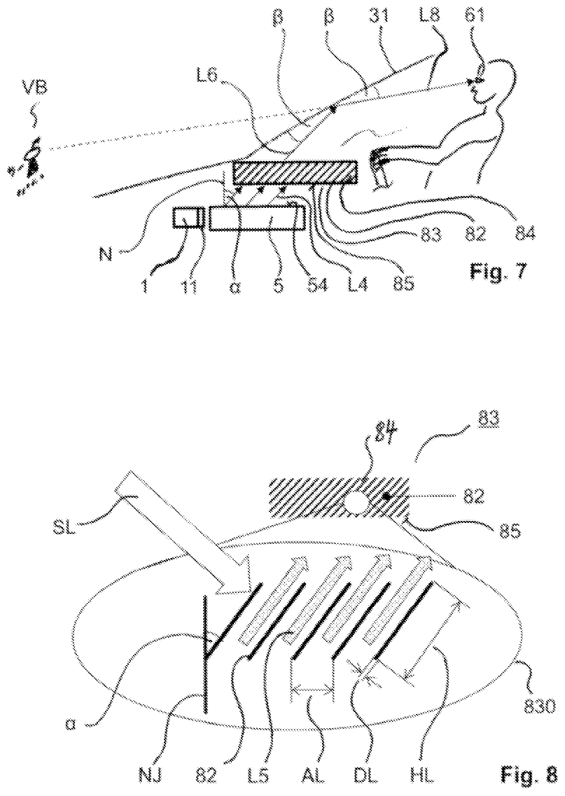

FIG. 7 shows an apparatus according to the disclosure, in which an optical waveguide 5 is used in a manner corresponding to FIG. 6. It shows the image generator 1 with display element 11 and the optical waveguide 5, from which light L4 emerges at an angle α with respect to the normal N to the light exit surface 54 of the optical waveguide 5, the angle α being greater than 0°. The emerging light L4 is incident on the light entry surface 85 of the shutter 83, the slats 82 of which are parallel to the emerging light L4 so that it may pass unimpeded through the intermediate spaces 84 between the slats 82. The light L6 emerging from the shutter 83 is incident on the windshield 31 at an angle β and is reflected thereby, and enters the eye 61 of a vehicle occupant, here the driver, as light L8. The driver therefore sees a virtual image VB. In this embodiment, the shutter 83 forms the cover for the optical unit, and any separate cover element that may be present must be moved away during operation. The shutter 83 may therefore also come in direct contact with objects or persons located in the interior of the vehicle. Damage to the shutter 83 is therefore not precluded. The shutter 83 is therefore preferably arranged releasably so that, if need be, it is removed without much effort and replaceable with a new or repaired shutter 83.

FIG. 8 shows the shutter 83 and a detail enlargement 830. It shows the slats 82, which let through the light L5 that emanates from the optical waveguide and travels substantially parallel to the slats 82. Stray light SL that does not travel parallel to the slats 82 is blocked by the slats 82. The slats 82 have a mutual spacing AL and are inclined by an angle α with respect to the normal NJ to the light entry surface 85 of the shutter 83. The slats have a height HL and a thickness DL, wherein the height HL is a multiple of the thickness DL. The angle α corresponds to that of the light emergence from the optical waveguide 5 when the light exit surface 54 of the latter and the light entry surface 85 of the shutter 83 are arranged parallel to one another. In the case of a non-parallel arrangement, these angles are to be converted accordingly. The angle α depends, inter alia, on the position of the driver and their angle of view. For different types of vehicle or different inclinations of the windshield 31, inter alia the distance AL needs to be adapted. The slats 82 are for example configured to be non-reflective, that is to say substantially black. If the slats are arranged so as to be tiltable, that is to say the angle α is variably settable during operation, they may be set to different positions of the eyebox, or to different positions of the eye 61 inside the eyebox. This assumes that the light emanating from the optical waveguide 5 covers a specific angle range so that, for each set angle α, light rays that are aligned parallel to the slats arrive on the latter and therefore pass through them.

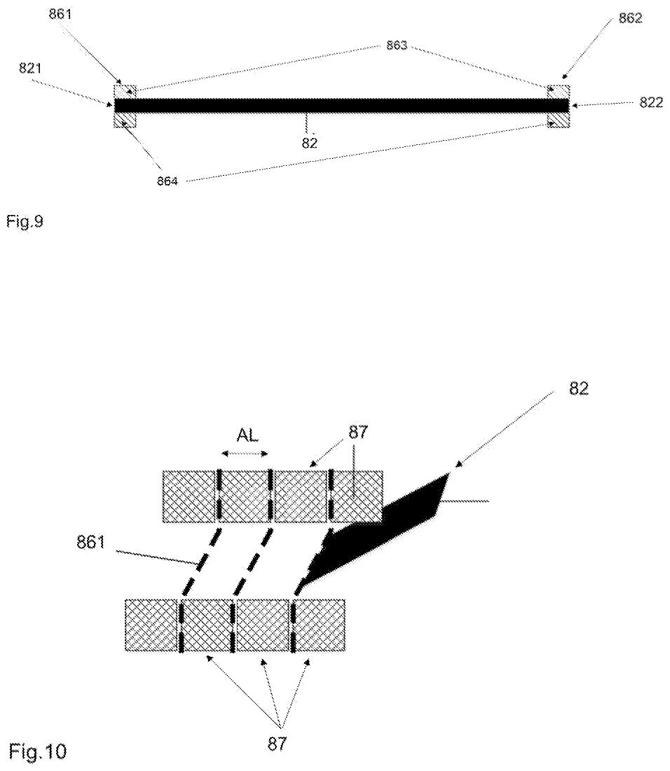

FIG. 9 shows a slat 82 which, according to the disclosure, has flat reinforcing elements 861, 862 in its end regions 821, 822. The reinforcing elements 861, 862 protrude beyond the slats 82, upward in the plane of the drawing, region 863, and downward, region 864. The individual slats 82 are therefore reinforced in a protruding manner with thin material at their ends. The reinforcing elements 861, 862 are additionally used as a spring mechanism, in a similar way to a leaf spring. The reinforcing elements 861, 862 are therefore configured as springs. The slat 82 represented is a solution for holding and/or adjusting slats 82 in an array of slats, i.e. the shutter 83, for the purpose of antireflection.

FIG. 10 shows an arrangement of spacer platelets 87 between reinforcing elements 861 in the intermediate spaces between two slats 82. For the sake of clarity, it shows only one slat 82 but a plurality of reinforcing elements 861, on each of which there is a slat (not shown here). The slat reinforcements, i.e. the reinforcing elements 861, are clamped on the upper and lower side by modular spacer platelets 87, which fill the pitch interstices of the slats 82, and are formed outside the visible region. According to an embodiment, the spacer platelets 87 may differ in their material thickness and thus define the spacing AL between the slats 82.

FIG. 11 shows an embodiment of the disclosure with an angle gradient. A plurality of reinforcing elements 861 are shown, between which spacer platelets 87 of equal material thickness are arranged in the lower region and spacer platelets 871, 872, 873 of different material thickness are arranged in the upper region. The angle between neighboring reinforcing elements 861 is therefore different, and so is the setting angle of the slats (not shown here) located on the reinforcing elements 861. The angle gradient is represented exaggeratedly here in order to illustrate the principle.

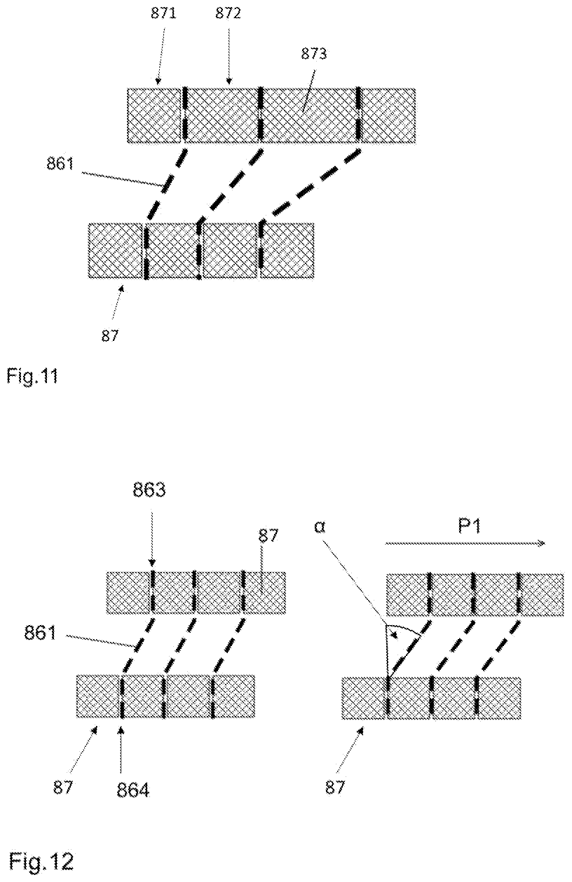

FIG. 12 shows a principle that the present disclosure makes possible for the adjustment of the setting angle α. The reinforcing elements 861 protrude upward and downward beyond the slats 82. The upwardly protruding regions 863 of the reinforcing elements 861 are arranged displaceably in relation to the downwardly protruding regions 864. The displacement is indicated by an arrow P1. It can be seen that the upwardly protruding regions 863 in the right part of the figure are displaced toward the right in relation to the left part of the figure. The setting angle α therefore changes. The adjustment of the slat angle is therefore carried out by displacing one of the platelet rows, in the illustration here the upper platelet row, or both platelet rows.

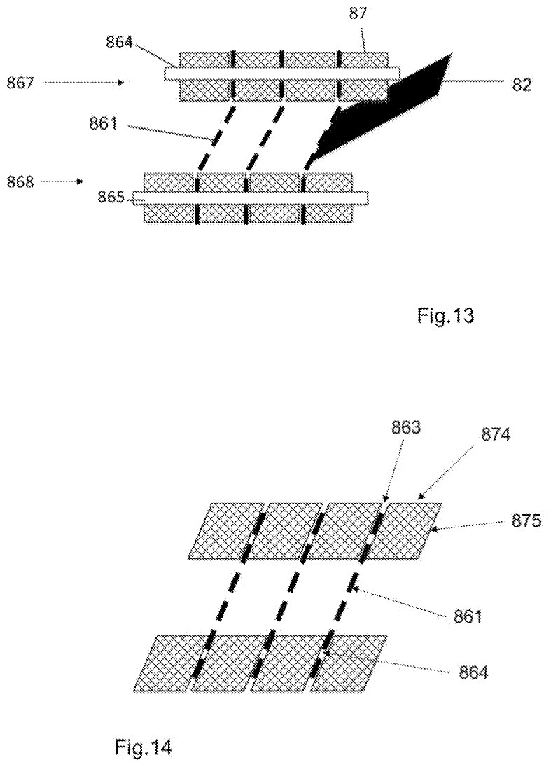

FIG. 13 shows fixing of the spacer platelets 87 by fixing elements 864, 865. In this embodiment variant, the spacer platelets 87 with clamped slat reinforcements 861 are aligned by fixing by fixing elements 864, 865, for example by a bar. The form an upper row 867 and a lower row 868.

FIG. 14 shows spacer platelets 874 which have a slant 875. The slant 875 corresponds to a preferred direction of the slats 82 (not shown here). It may be seen that the reinforcing elements 861 arranged on the slats 82 in the figure, which corresponds to said preferred direction, does not have an angle between its main part and the regions 863, 864 respectively protruding upward and downward. A preliminary angle setting is therefore possible by selecting the platelet shape. In this embodiment variant, the shape of the spacer platelets 874 is selected in such a way that a preliminary angle setting of the slats 82 takes place and no prestress, or only a minor prestress, of the reinforcing elements 861 that act as spring elements is thus necessary. The arrangement consisting of reinforcing elements 871 and spacer platelets 874 is located on the product outside the optical functional region. This applies to all exemplary embodiments shown.

In other words, the disclosure relates to the following: a modular adjustment mechanism for antireflection slats is proposed. Currently, only antireflection means or visual protection methods with a fixed angle, usually perpendicular to the surface, are provided for picture generating methods, for example for telescopes, projectors or monitors. Examples include a visual protection film for cell phones, an antireflection apparatus for telescopes or the like, or instruments with a coarsely adjustable transmission angle, for example shutters for windows. In head-up displays, antireflection is often achieved by a glare trap with a curved foil. This design entails a minimum installation depth corresponding to the foil curvature. For windshield head-up displays, antireflection is provided by slats or a grid structure as a terminating assembly. Particularly for waveguide head-up displays in flat design, an antireflection solution is needed since in this case flat glass components are located directly below the windshield. This solution should be adjustable in angle in order to reduce shadowing in the eyebox. One possible solution provides slats clamped in a frame for antireflection.

Different setting angles of the slats are needed for different eyebox positions, in order to avoid undesired shadowing. There has hitherto been no reliable solution to allow angle adjustment of the slats. The non-adjustable methods do not allow the system to adapt to the viewer. The viewing angle and angle range for visual/reflection protection are the same or dependent on one another. The assembly is furthermore installed directly behind the windshield so that large thermal stresses may occur, for example due to sunlight.

For applications that are intended to allow only a particularly narrow light incidence angle, but are intended at the same time to allow a larger viewing/transmission angle range and a high transmittance, a very fine setting of the transmission angle and very little coverage in the transmission region are necessary. A dependence on external influences, such as temperature or humidity, on the setting angle should be as small as possible.

The solution according to the disclosure has inter alia the following advantages, which may apply only individually or in combination, depending on the embodiment. The modular adjustment mechanism allows entirely free definition of the spacing between neighboring spring elements. The spacing between the individual elements may, in particular, be much less than in the case of a one-piece leaf spring or a coil spring. The angle that is set is independent of temperature because the spacers expand and contract uniformly on both sides. The material thickness and the type of the reinforcing elements allow small adjustment forces. The stiffness is ensured by means of the spacer platelets 87, which have a higher material thickness and material selection of which is independent of the reinforcing elements 861 acting as spring elements.

The modular adjustment mechanism is compact since its overall width corresponds only to the width of the spring element, and no lateral stabilization is necessary. This is not explicitly shown in the figures but will be understood by a person skilled in the art. Other approaches work with a holding element and an adjustment element. By the approach according to the disclosure, these functions may be combined.

The solution according to the disclosure may also be employed in conventional head-up displays (for example based on mirrors). Here, the anti-glare element is preferably used as a terminating assembly. The solution according to the disclosure may also be used as adjustable antireflection inside assemblies. The anti-glare element is then integrated into the assembly. The solution according to the disclosure may also be used as visual protection for displays (privacy filter) as an adaptive solution. The solution according to the disclosure may also be used as visual protection for windows/domelight windows (smartwindows) for brightness setting. In automobile manufacture, for example, it is useful to provide protection for the user or cameras of a vehicle against dazzling by lidar apparatuses, for example in conjunction with a system for level control of the vehicle. The disclosure may also be used in the aerospace sector, for example for glare protection of optical measuring instruments or for the precise spatial resolution of radiation sources.

1. An apparatus for generating a virtual image, having:
a display element for generating an image;
an optical waveguide for expanding an exit pupil; and
an anti-glare element arranged downstream of the optical waveguide in the beam path, wherein
the anti-glare element is a shutter that has a plurality of slats which, in the direction of their longest extent, have end regions that have flat reinforcing elements which protrude beyond the slats.

2. The apparatus as claimed in claim 1, wherein the reinforcing elements protrude beyond the slats in a direction perpendicular to the direction of the longest extent of the slats.

3. The apparatus as claimed in claim 2, wherein the reinforcing elements protrude beyond the slats in the direction the height of the slats.

4. The apparatus as claimed in claim 1, wherein the reinforcing elements are resiliently configured.

5. The apparatus as claimed in claim 1, wherein spacer platelets are arranged between the reinforcing elements of neighboring slats.

6. The apparatus as claimed in claim 5, wherein the spacer platelets have a different material thickness at different locations of the shutter.

7. The apparatus as claimed in claim 1, wherein the reinforcing elements protrude upward and downward beyond the slats, and the upwardly protruding regions of the reinforcing elements are arranged displaceably in relation to the downwardly protruding regions of the reinforcing elements.

8. The apparatus as claimed in claim 7, wherein spacer platelets arranged respectively between the upwardly or downwardly protruding regions are fixed by means of fixing elements to an upper or lower row.

9. The apparatus as claimed in claim 5, wherein the spacer platelets have a slant which corresponds to a preferred direction of the slats.
